(19) United States
(12) Patent Application Publication
(10) Pub. No.: US 2025/0105408 A1
(43) Pub. Date: Mar. 27, 2025

(54) SECONDARY BATTERY

(71) Applicant: Samsung SDI Co., Ltd., Yongin-si (KR)

(72) Inventors: In Hyun HWANG, Yongin-si (KR); Ha Ram YEO, Yongin-si (KR); Bum Rae KIM, Yongin-si (KR); Da Hyun KIM, Yongin-si (KR); Byong Gon LEE, Yongin-si (KR)

(21) Appl. No.: 18/653,861

(22) Filed: May 2, 2024

(30) Foreign Application Priority Data
Sep. 21, 2023 (KR) 10-2023-0126148

(51) Int. Cl. H01M 50/15; H01M 50/103; H01M 50/169

(52) U.S. Cl. CPC H01M 50/15; H01M 50/103; H01M 50/169

(57) ABSTRACT

A secondary battery includes: a case having an open end; an electrode assembly accommodated in the case; and a cap assembly coupled to the open end of the case and including a cap plate. A portion of the cap plate coupled to the case is thicker than other portions of the cap plate.

### CROSS-REFERENCE TO RELATED APPLICATION

This application claims priority to and the benefit of Korean Patent Application No. 10-2023-0126148, filed on Sep. 21, 2023, in the Korean Intellectual Property Office, the disclosure of which is incorporated by reference herein in its entirety.

### BACKGROUND

### 1. Field

Aspects of embodiments of the present disclosure relate to a secondary battery.

### 2. Description of the Related Art

Secondary batteries can be classified into pouch-type, prismatic, or cylindrical shapes depending on the shape of the case. The prismatic secondary battery generally includes an electrode assembly that is laminated or wound with a separator interposed between positive and negative electrode plates, a rectangular parallelepiped case that accommodates the electrode assembly with an electrolyte, and a cap assembly that seals the case. The cap assembly includes a cap plate that is welded to the case.

Generally, the cap plate of a prismatic battery is a straight plate and is connected to the case by welding along its edge. Because secondary batteries are repeatedly charged and discharged, pressure is created when gas is generated inside the case. However, a large amount of gas may be suddenly generated due to an event, such as an internal short circuit. However, to secure battery capacity, the thickness of the case and cap plate is gradually decreased, and thus, there is a high risk of damage to welded areas that are vulnerable to internal pressure.

The above information disclosed in this Background section is for enhancement of understanding of the background of the present disclosure, and therefore, it may contain information that does not constitute prior art.

### SUMMARY

Embodiments of the present disclosure provide a secondary battery having improved pressure resistance performance even at the same welding depth.

A secondary battery, according to an embodiment of the present disclosure, includes: a case having an open end; an electrode assembly accommodated in the case; and a cap assembly coupled to the open end of the case and including a cap plate. A portion of the cap plate coupled to the case is thicker than other portions of the cap plate.

The case may have a rectangular parallelepiped shape, the cap plate may have a rectangular plate shape, and a lower side of a long side portion of the cap plate may be extended to form an extension portion.

The extension portion of the cap plate may have a greater thickness than other portions of the cap plate.

A surface extending between the end of the extension portion and the lower surface of the cap plate may have a streamlined cross-section.

A surface extending between the end of the extension portion and the lower surface of the cap plate may have a straight cross-section.

A surface extending between the end of the extension portion and the lower surface of the cap plate may have a stepped cross-section.

A secondary battery, according to another embodiment of the present disclosure, includes: a case having an open end; an electrode assembly accommodated in the case; and a cap assembly coupled to the open end of the case and including a cap plate. The cap plate has an extension portion at where lower portions of side surfaces of the cap plate, which face each other, extending toward the electrode assembly.

The case may have a rectangular parallelepiped shape, the cap plate may have a rectangular plate shape, and a lower side of a long side portion of the cap plate may be extended to form the extension portion.

The extension portion of the cap plate may have a greater thickness than other portions of the cap plate.

A surface extending between the end of the extension portion and the lower surface of the cap plate may have a streamlined cross-section.

A surface extending between the end of the extension portion and the lower surface of the cap plate may have a straight cross-section.

A surface extending between the end of the extension portion and the lower surface of the cap plate may have a stepped cross-section.

### BRIEF DESCRIPTION OF DRAWINGS

FIG. 1 is a perspective view of a secondary battery according to an embodiment of the present disclosure.

FIG. 2 is an exploded perspective view of a cap assembly and a current collection structure of the secondary battery shown in FIG. 1.

FIG. 3 is a perspective view showing the cap assembly and an electrode assembly of the secondary battery shown in FIG. 1.

FIG. 4 is a partially exploded perspective view of a secondary battery according to another embodiment of the present disclosure.

FIG. 5 is a partial cross-sectional perspective view showing a structure of the case and the cap plate according to an embodiment of the present disclosure.

FIGS. 6 and 7 are partial cross-sectional perspective views showing a structure of a case and a cap plate according to other embodiments of the present disclosure.

### DETAILED DESCRIPTION

Embodiments of the present disclosure are provided to more fully describe the present disclosure to those skilled in the art, and the present disclosure may be embodied in many different forms and should not be construed as being limited to the embodiments set forth herein. Rather, these embodiments are provided so that this disclosure will be thorough and complete and will convey the aspects and features of the present disclosure to those skilled in the art.

In addition, in the accompanying drawings, sizes or thicknesses of various components are exaggerated for brevity and clarity. Like numbers refer to like elements throughout.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof.

The terminology used herein is for the purpose of describing particular embodiments only and is not intended to be limiting of the disclosure.

As used herein, the singular forms are intended to include the plural forms as well, unless the context clearly indicates otherwise. It will be further understood that the terms that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present invention.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

Hereinafter, a secondary battery according to embodiments of the present disclosure will be described in detail with reference to the accompanying drawings.

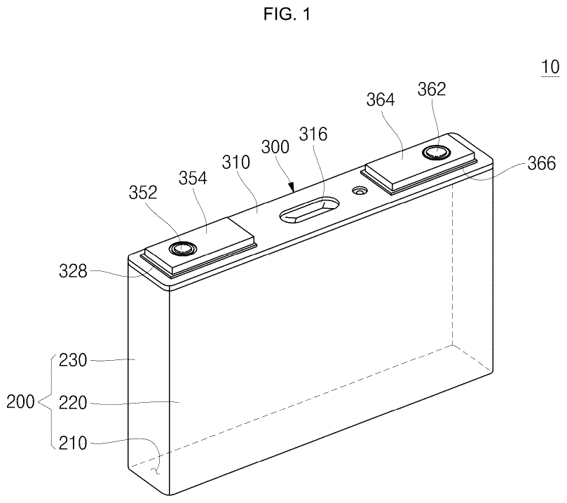

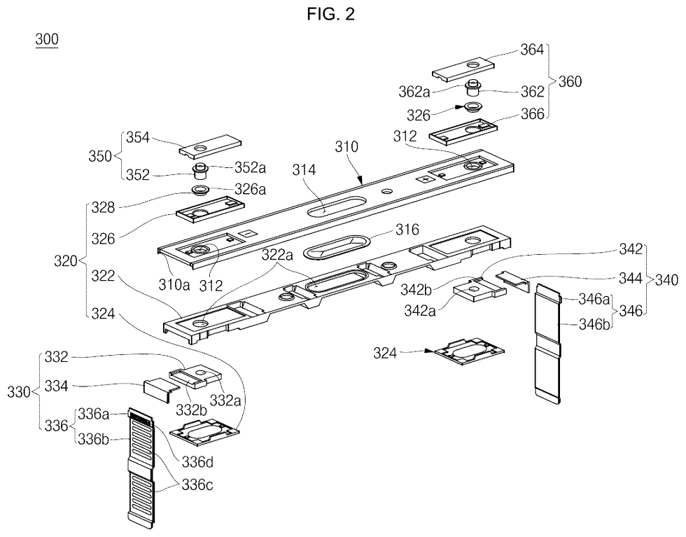

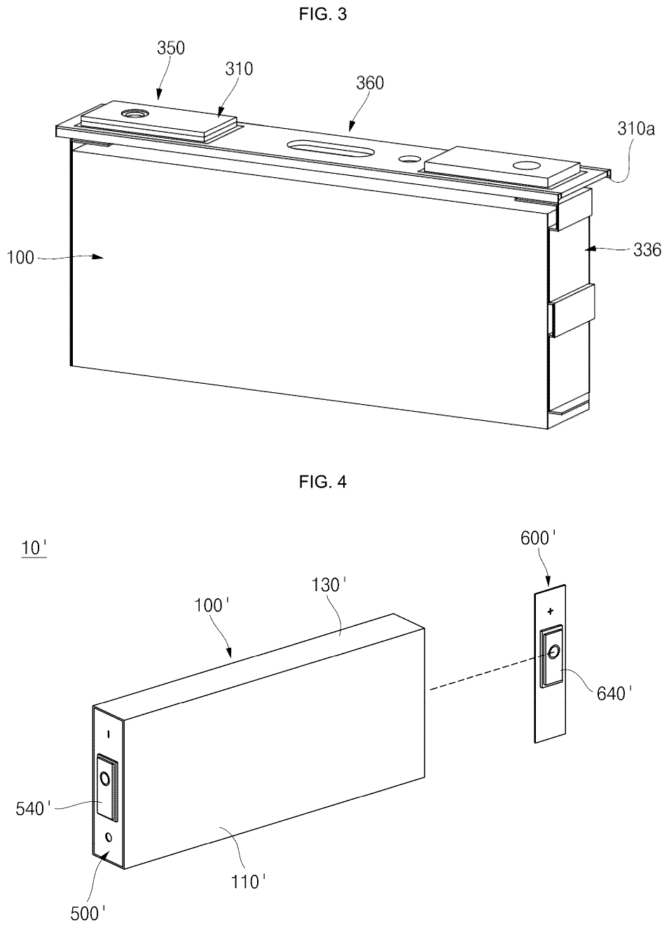

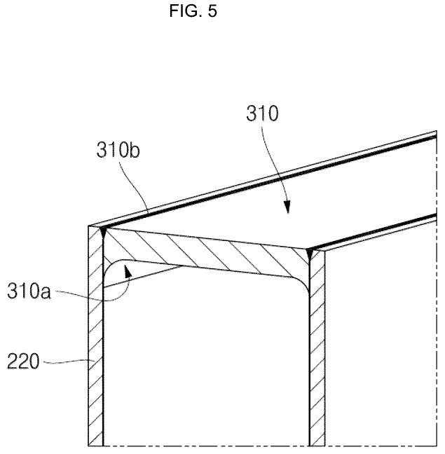

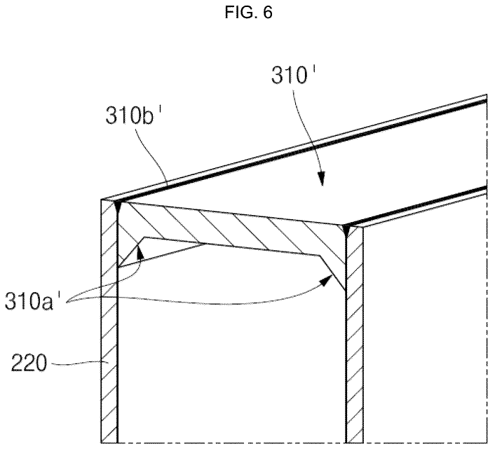

FIG. 1 is a perspective view of a secondary battery according to an embodiment of the present disclosure. FIG. 2 is an exploded perspective view showing a cap assembly and a current collection structure of the secondary battery shown in FIG. 1. FIG. 3 is a perspective view of the cap assembly and an electrode assembly of the secondary battery shown in FIG. 1. FIG. 4 is a partially exploded perspective view of a secondary battery according to another embodiment of the present disclosure. FIG. 5 is a partial cross-sectional perspective view showing a structure of the case and the cap plate according to an embodiment of the present disclosure.

Referring to FIGS. 1 to 3, the secondary battery 10 according to an embodiment of the present disclosure may include an electrode assembly 100, a case 200 accommodating the electrode assembly 100, and a cap assembly 300 coupled to the case 200. Referring to FIG. 4, a secondary battery 10′ according to another embodiment of the present disclosure may include a pair of cap assemblies 500′ and 600′.

As shown in FIG. 3, the electrode assembly 100 may be provided by winding a unit stack including of a first electrode plate and a second electrode plate, which have a thin plate or film shape, or by stacking a plurality of unit stacks. When the electrode assembly 100 is formed by winding, the winding axis may be in a horizontal direction substantially parallel to the longitudinal direction of the cap assembly 300 or in a vertical direction approximately perpendicular to the longitudinal direction of the cap assembly 300. When the electrode assembly 100 is formed by stacking, a plurality of unit stacks may be arranged such that long side surfaces thereof are adjacent to each other. As an example, the first electrode plate may be a negative electrode, and the second electrode plate may be a positive electrode, but the opposite configuration is possible.

When the first electrode plate is a negative electrode plate, the first electrode plate is formed by applying a first electrode active material, such as graphite or carbon, to a first electrode current collector formed of (or provided with) a metal foil, such as copper, a copper alloy, nickel, or a nickel alloy. A first substrate tab (e.g., a first uncoated region), which is a region at where the first electrode active material is not applied, may be formed on the first electrode plate. A plurality of the first substrate tabs may be bent to one side and welded to a current collection part, which will be described in more detail later. The current collection part may be electrically connected to the cap assembly 300.

When the second electrode plate is a positive electrode plate, the second electrode plate may be formed by applying a second electrode active material, such as a transition metal oxide, to a second electrode current collector formed of (or provided with) a metal foil, such as aluminum or an aluminum alloy. A second substrate tab (or a second uncoated region), which is a region at where the second electrode active material is not applied, may be formed on the second electrode plate. A plurality of the second substrate tabs may be bent to one side and welded to a current collection part. The current collection part may be electrically connected to the cap assembly 300.

The separator is disposed between the first electrode plate and the second electrode plate to prevent a short circuit therebetween while enabling the movement of lithium ions. As an example, the separator may include polyethylene, polypropylene, or a composite film of polyethylene and polypropylene but is not limited to the above-mentioned materials.

The electrode assembly 100 having the above-described structure can be accommodated in the case 200 together with an electrolyte. In some examples, the electrolyte may include a lithium salt, such as LiPF₆ or LiBF₄, in an organic solvent, such as ethylene carbonate (EC), propylene carbonate (PC), diethyl carbonate (DEC), ethyl methyl carbonate (EMC), or dimethyl carbonate (DMC). In addition, the electrolyte may be liquid or gel. In some examples, when an inorganic solid electrolyte is used, the liquid or gel electrolyte may be omitted.

Because the aforementioned structure of the electrode assembly 100 can be equally applied to the embodiment shown FIG. 4, a repeated detailed description is omitted.

The case 200, having a substantially rectangular box shape, may have an upper portion that is open in the longitudinal direction and may have a receiving space formed therein. The electrode assembly 100 and the electrolyte may be accommodated inside the case 200 through the open upper portion. Some components of the cap assembly 300 may be exposed to the outside of the case 200, and some components thereof may be accommodated inside the case 200. The case 200 may be have a rectangular bottom surface 210 and four side surfaces connected to (or extending from) the bottom surface 210. From among the side surfaces, the surfaces having a relatively large area are defined as the long side portions 220, and the surfaces having a relatively small area are defined as the short side portions 230. As an example, the electrode assembly 100 may be arranged so that a plate surface (or a substantially flat surface) faces the long side portion 220. When the electrode assembly 100 is accommodated in the case 200, the cap assembly 300 is coupled to the case 200 and is electrically connected to the electrode assembly 100. An insulating film for insulating the case 200 from the current collection part may be coupled, to attached to, or formed on the short side portion 230 of the case 200.

Alternatively, as shown in FIG. 4, a case 100′ may have a pair of long side portions 110′ and a pair of short side portions 130′ and may be open at both ends (e.g., opposite ends) in the longitudinal direction of the case 100′. Cap assemblies 500′ and 600′ may be provided at both ends in the longitudinal direction, respectively. The pair of cap assemblies 500′ and 600′ may respectively include a first terminal portion 540′ and a second terminal portion 640′. The first terminal portion 540′ and the second terminal portion 640′ may each be electrically connected to the electrode assembly by a current collector similar to a sub plate 336, which will be described later. Hereinafter, for convenience, the welding connection between the cap plate and the case will be described based on the cap assembly shown in FIG. 2. However, the welding structure to be described later may be equally applied to the embodiment shown in FIG. 4.

As shown in FIGS. 1 to 3 and 5, the cap assembly 300 may include a cap plate 310 coupled to the case 200, a plurality of insulating members, a first current collection part 330, a second current collection part 340, a first terminal portion 350, and a second terminal portion 360 (hereinafter, only the configuration related to the welded structure according to an embodiment of the present disclosure will be described in detail).

First, as shown in FIGS. 1 to 3, the cap plate 310 has a substantially rectangular plate shape and may be formed of the same material as the case 200. An extension portion 310a may be provided below the long side portion of the cap plate 310. The upper edge of the long side portion of the cap plate 310 may be welded to the upper side of the long side portion of the case 200. In the cap plate 310, terminal holes (e.g., terminal openings) 312 and a groove for coupling with the first terminal portion 350 and the second terminal portion 360, an injection hole (e.g., an injection opening), and a vent hole (e.g., a vent opening) 314 for coupling the vent 316 may be formed.

Referring to FIG. 5, the extension portion 310a is provided along the long side portion of the cap plate 310. Therefore, the extension portion 310a may be a pair. The extension portion 310a is formed by extending a portion of the lower surface of the long side portion of the cap plate 310. The extension portion 310a may be in the form of an extension of the side surface of the cap plate 310 that is in contact with the long side portion 220 of the case 200. In the illustrated embodiment, the cross-section from the end of the extension portion 310a, which is in contact with the long side portion 220 of the case 200, to the lower surface of the cap plate 310 may be streamlined (e.g. may be smoothly curved). The streamlined surface connecting the end of the extension portion 310a and the lower surface of the cap plate 310 is defined as the inner side surface of the extension portion 310a. For example, the inner side surface of the extension portion 310a according to the embodiment shown in FIG. 5 is provided in a streamlined shape. This shape is generally referred to as an R shape, round shape, etc. By including the extension portion 310a, the thickness of a welded portion is increased. Therefore, improved pressure resistance performance can be secured even at the same welding depth. In addition, because the bonding strength between the case and the cap plate is improved, fracture of the welded portion of the cap plate can be prevented even if gas is suddenly generated during an event (e.g., during a thermal event). A welded portion 310b may be formed on the upper portion of the extension portion 310a.

The welded portion 310b may be a region in which the upper end of the long side portion 220 of the case 200 and the upper end of the long side portion of the cap plate 310 are in contact with each other. The welded portion 310b is formed along the longitudinal direction of the cap plate 310 and, thus, may be located approximately at the upper portion of the extension portion 310a. A same or substantially similar welded portion is formed on the short side portion of the cap plate 310 but is not shown in the drawing, for convenience.

Insulating members include an insulating plate 322, a pair of lower insulating parts 324, a pair of pin insulating parts 326, and an upper insulating part 328. The insulating members may be made of insulating materials.

The first current collection part 330 electrically connects the first electrode plate 110, which is, in one embodiment, a negative electrode plate, and the first terminal portion 350. The first current collection part 330 may include a first current collector 332 electrically connected to the first terminal portion 350, a connection plate 334 electrically connected to the first current collector 332, and a sub plate 336 electrically connected to the connection plate 334 and the first substrate tab.

The sub plate 336 may be made of a conductive material having a width and length and may be approximately plate-shaped. One end (e.g., a top end) of the sub plate 336 may be welded while being in contact with the lower portion of the connection plate 334. From among the plate surfaces of the sub plate 336, the surface facing the electrode assembly 100 is defined as the inner surface, and the side facing the short side portion 230 of the case 200 is defined as the outer surface. Then, the first substrate tab may be connected to the inner surface of the sub plate 336. A portion at where the sub plate 336 is connected to the connection plate 334 may be defined as a first connection part 336a, and a portion at where the sub plate 336 is connected to the first substrate tab may be defined as a second connection part 336b. The first connection part 336a and the second connection part 336b of the sub plate 336 may be bent at an angle (e.g., at a predetermined angle). As an example, the inner surface of the second connection part 336b may be bent from the first connection part 336a toward the electrode assembly 100 and may be arranged to be located on the same plane as the inner surface of the connection plate 334. In another embodiment, the inner surface of the second connection part 336b may be arranged to be further recessed into (or toward) the electrode assembly 100 than the inner surface of the connection plate 334. The inner surface of the second connection part 336b may be connected to the first substrate tab by laser welding, which will be described later. In addition, a plurality of concave welding grooves 336c may be formed on the outer surface of the second connection part 336b or may be omitted.

As described above, the first current collector 332, which is relatively thick, may be formed in a straight line, and the connection plate 334 and the sub plate 336 are relatively thin, thereby securing a space for increasing the size of the electrode assembly 100.

The second current collection part 340 has the same configuration as the first current collection part 330 but is arranged symmetrically to the first current collection part 330 and is electrically connected to the second electrode plate. A detailed description of the second current collection part 340 will be omitted.

The first terminal portion 350 may include a first terminal pin 352 and a first terminal plate 354. The first terminal portion 350 may further include a fixing plate for fixing the first terminal pin 352, in some embodiments. The first terminal pin 352 has a substantially cylindrical shape and is electrically connected to the first current collector 332 and, thus, may be electrically connected to the first electrode plate of the electrode assembly 100.

The second terminal portion 360 may include a second terminal pin 362, a second terminal plate 364, a conductive plate 366, and a fixing plate. The second terminal pin 362, the second terminal plate 364, and the fixing plate are configured in the same manner as the first terminal portion 350 and are arranged to be symmetrical to the first terminal portion 350. The conductive plate 366 electrically connects the second terminal plate 364, which is electrically connected to the second terminal pin 362, and the cap plate 310. Accordingly, the cap plate 310 is connected to the second current collection part 340 through the second terminal portion 360 and, thus, may be electrically connected to the second electrode plate of the electrode assembly 100. Therefore, the cap plate 310 has a positive polarity, which is the same as the second current collection part 340, and the case 200, which is welded to the cap plate 310, also has a positive polarity.

The above-described secondary battery may include a different type of cap plate.

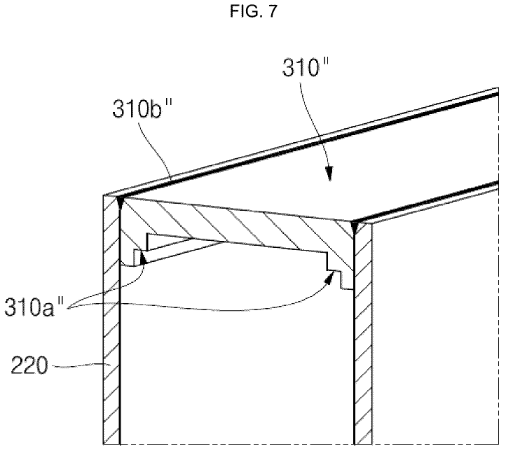

FIGS. 6 and 7 are partial cross-sectional perspective views showing a welded structure of a case and a cap plate according to other embodiments of the present disclosure.

A cap plate 310′ shown in FIG. 6 is similar to that shown in FIG. 5 but differs with respect to the shape of an extension portion 310a′. The extension portion 310a′ shown in FIG. 6 is formed by extending a portion of the lower surface of the long side portion of the cap plate 310′. The extension portion 310a′ may be in the form of an extension of the side surface of the cap plate 310′ in contact with the long side portion 220 of the case 200. In this embodiment, the extension portion 310a′ may be in the form of an extension of the side surface of the cap plate 310′ that is in contact with the long side portion 220 of the case 200. The cross section from the end of the extension portion 310a′, which is in contact with the long side portion 220 of the case 200, to the lower surface of the cap plate 310′ may be a straight line. For example, the inner surface of the extension portion 310a′ according to the embodiment shown in FIG. 6 may be a straight inclined surface rather than a streamlined (or curved) surface as shown in, for example, FIG. 5.

Alternatively, a cap plate 310″ shown in FIG. 7 is similar to that of the embodiment shown in FIG. 5 but differs with respect to the shape of an extension portion 310a″. The extension portion 310a″ shown in FIG. 7 may be formed by extending a portion the lower surface of the long side portion of the cap plate 310′. The extension portion 310a″ may be in the form of an extension of the side surface of the cap plate 310″ that is in contact with the long side portion 220 of the case 200. In this embodiment, the cross section from the end of the extension portion 310a″, which is in contact with the long side portion 220 of the case 200, to the lower surface of the cap plate 310″ may have a step (or stepped) shape. For example, the inner surface of the extension portion 310a″ according to the embodiment shown in FIG. 7 may be a stepped surface.

By including the aforementioned extension portions (e.g., 310a, 310a′, and 310a″), the thickness of the welded portion may be increased. Therefore, improved pressure resistance performance can be secured even at the same welding depth. In addition, because the bonding strength between the case and the cap plate is improved, fracture of the welded portion of the cap plate can be mitigated or prevented even if gas is suddenly generated during an event.

As described above, according to embodiments of the present disclosure, by improving the shape of a welded portion of a cap plate, improved pressure resistance performance can be secured even at the same welding depth. In addition, because the bonding strength between a case and the cap plate is improved, fracture of the welded portion of the cap plate can be mitigated or prevented even if gas is suddenly generated during an event.

While the foregoing embodiments have been described in connection with the present disclosure, it should be understood that the embodiments described herein should be considered in a descriptive sense and not for purposes of limitation, and various changes in form and details may be made therein without departing from the spirit and scope of the disclosure as defined by the following claims and their equivalents.

What is claimed is:

1. A secondary battery comprising:
a case having an open end;
an electrode assembly accommodated in the case; and
a cap assembly coupled to the open end of the case and comprising a cap plate, a portion of the cap plate coupled to the case being thicker than other portions of the cap plate.

2. The secondary battery as claimed in claim 1, wherein the case has a rectangular parallelepiped shape, the cap plate has a rectangular plate shape, and a lower side of a long side portion of the cap plate is extended to form an extension portion.

3. The secondary battery as claimed in claim 2, wherein the extension portion of the cap plate has a greater thickness than other portions of the cap plate.

4. The secondary battery as claimed in claim 3, wherein a surface extending between the end of the extension portion and the lower surface of the cap plate has a streamlined cross-section.

5. The secondary battery as claimed in claim 3, wherein a surface extending between the end of the extension portion and the lower surface of the cap plate has a straight cross-section.

6. The secondary battery as claimed in claim 3, wherein a surface extending between the end of the extension portion and the lower surface of the cap plate has a stepped cross-section.

7. A secondary battery comprising:
a case having an open end;
an electrode assembly accommodated in the case; and
a cap assembly coupled to the open end of the case and comprising a cap plate, the cap plate having an extension portion at where lower portions of side surfaces of the cap plate, which face each other, extending toward the electrode assembly.

8. The secondary battery as claimed in claim 7, wherein the case has a rectangular parallelepiped shape, the cap plate has a rectangular plate shape, and a lower side of a long side portion of the cap plate is extended to form the extension portion.

9. The secondary battery as claimed in claim 8, wherein the extension portion of the cap plate has a greater thickness than other portions of the cap plate.

10. The secondary battery as claimed in claim 8, wherein a surface extending between the end of the extension portion and the lower surface of the cap plate has a streamlined cross-section.

11. The secondary battery as claimed in claim 8, wherein a surface extending between the end of the extension portion and the lower surface of the cap plate has a straight cross-section.

12. The secondary battery as claimed in claim 8, wherein a surface extending between the end of the extension portion and the lower surface of the cap plate has a stepped cross-section.
